(19) United States
(12) Patent Application Publication
(10) Pub. No.: US 2015/0167448 A1
(43) Pub. Date: Jun. 18, 2015

(54) DOWNHOLE SENSOR

(71) Applicant: SCHLUMBERGER TECHNOLOGY CORPORATION, Sugar Land, TX (US)

(72) Inventors: Rim Kamilevich Valiullin, Ufa (RU); Rashid Kamilevich Yarullin, Ufa (RU); Airat Rashidovich Yarullin, Ufa (RU); Anton Vladimirovich Parshin, Ufa (RU); Valery Vasilievich Shako, Moscow (RU); Sergey Sergeevich Safonov, Moscow (RU)

(21) Appl. No.: 14/406,721

(22) PCT Filed: Jun. 7, 2013
(86) PCT No.: PCT/RU2013/000474

§ 371 Date: Dec. 9, 2014

(30) Foreign Application Priority Data
Jun. 9, 2012 (RU) 2012123866

(51) Int. Cl. E21B 47/10; G01P 5/00

(52) U.S. Cl. CPC E21B 47/1005; G01P 5/001

(57) ABSTRACT

The downhole sensor is intended for measuring fluid flow parameters. It comprises two identical hollow metal housings opened at one end, whose symmetry axes are aligned. The open ends of the housings face each other and are rigidly fastened in the electrical insulator. A thermoanemometer sensor is arranged in each housing. Electrical leads of the sensors are within the cavities of the housings and extend outside through the electrical insulator.

### FIELD OF THE INVENTION

The invention relates to devices for measuring flow parameters of fluid (oil, water, gas and mixtures thereof) such as temperature, velocity and gas composition, and can be used in geophysical studies of boreholes as well as in monitoring transportation of liquid hydrocarbons through a pipeline system.

### BACKGROUND ART

It is known a downhole hot-wire thermoanemometer disclosed in SU 440,484. The thermoanemometer comprises a sealed housing made as two cavities one of which contains a heating element arranged therein while another one contains a thermosensitive element arranged therein.

The disadvantages of the known thermoanemometer are:
there is no way to measure a temperature and a velocity of a fluid flow simultaneously, because the thermosensitive element measures the temperature only when the heater is turned off;
switching into a fluid temperature measurement mode requires a certain amount of time during which the heater will get cold and will not have an influence upon operation of the thermosensitive element, wherein the fluid temperature and composition can be much different from the initial values, which situation affects the reliability of received information;
the fluid flow velocity is calculated according to the complicated algorithm with taking into account a mass flow rate of the fluid and thermophysical properties thereof;
the monitoring of the fluid composition is absent.

Also known is a downhole sensor disclosed in SU 2,384,699. The sensor comprises an electrical insulator and a hollow cylindrical metal housing with a thermoanemometer sensor arranged in a cavity thereof.

The disadvantages of the prior art sensor are:
there is no way to measure a temperature and a velocity of a fluid flow simultaneously, because the temperature is measured only when the thermoanemometer heater is turned off;
the switching into a fluid temperature measurement mode requires a certain amount of time during which the heater will get cold and will not have an influence upon operation of the thermosensitive element, wherein the fluid temperature and composition can be much different from the initial values, which situation affects the reliability of received information;
the presence of a dielectric layer on the external surface of the hollow cylindrical housing of the thermoanemometer, said layer having an essential influence upon the heat exchange between the housing and the fluid, as a consequence of which metrological characteristics of the thermoanemometer deteriorate.

### SUMMARY

The disclosure provides for enhanced functionality of the sensor and increased measurement efficiency.

A downhole sensor comprises a hollow metal housing opened at one end and having a thermoanemometer sensor arranged in a cavity thereof, an electrical insulator, a second hollow housing opened at one end, identical to the first housing and having a second thermoanemometer sensor arranged in a cavity thereof. At the same time, symmetry axes of the housings are aligned, open ends of the housings face each other and are rigidly fastened in the electrical insulator and electrical leads of the sensors are within the cavities of the housings and extend outside through the electrical insulator.

The electrical insulator can be coated with a dielectric layer and also can have a shape which provides minimal flow structure distortion. The sensor housings also can be embodied so as to provide minimal flow structure distortions, for example, as a cylinder or a cone.

### BRIEF DESCRIPTION OF DRAWINGS

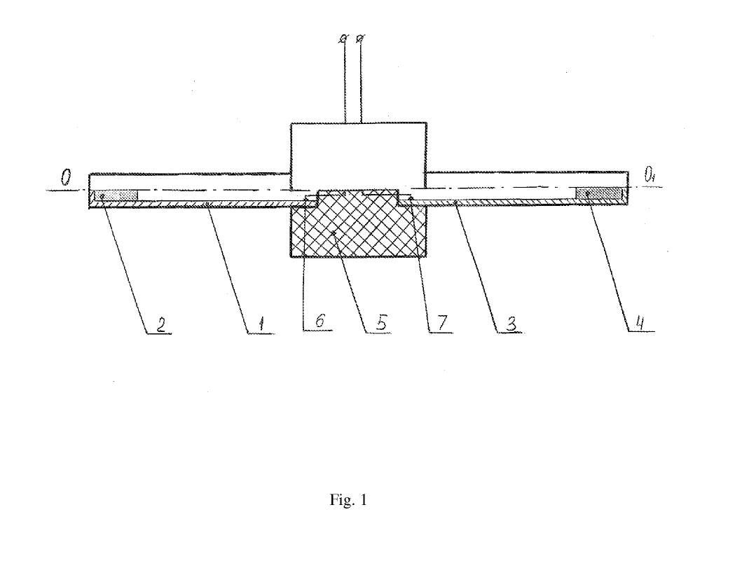

The invention is illustrated with the drawing where FIG. 1 shows a downhole sensor of the invention.

### DETAILED DESCRIPTION

The downhole sensor comprises a first hollow metal housing 1 having a thermoanemometer sensor 2 arranged in a cavity thereof and a second hollow housing 3 having a thermoanemometer sensor 4 arranged in a cavity thereof. Symmetry axes of the housings 1 and 3 are on one line O-O, the sensor housings are electrically insulated from each other by an electrical insulator 5 and are rigidly terminated therein from sides of open ends. The metal housings 1 and 3 of the thermoanemometer sensors to inner surfaces of which electrical leads 6 and 7 are connected are electrodes of a fluid composition resistive sensor. The thermoanemometer sensor 2 as well as the sensor 4 consists of a heating element and a temperature sensor (not shown in the drawing), has a thermal contact with an inner surface of a respective hollow metal housing and is electrically insulated therefrom. The heating element and the temperature sensor are electrically insulated from each other as well. Such sensors are described, for example in “Skvazninny termoconductivny debitometer STD” (Downhole Thermodonductive Flowmeter DTF). I. G. Zhuvagin, S. G. Komarov, V. B. Cherny.—“Nedra” (Depths Publishers), or in “Geofizicheskie issledovania skvazhin: spravochnik mastera po promyslovoi geofizike” (Geophysical Studies of Boreholes: Oilfield Geophysics Handbook of Foreman)/Under the general editorship of V. G. Martynov, N. E. Lazutkina, M. S. Khokhlova.—Moscow: “Infrainzheneria” (Infra-Engineering Publishers), 2009.

The electrical leads of the sensors 2 and 4 pass within the cavities of the respective housings, extend outside through the electrical insulator 5 and are coupled to an electronic unit (not shown in the drawing). To improve moisture resistance and chemical resistance, the electrical insulator can be coated with an additional dielectric layer (not shown in the drawing), while a the insulator and the housings 1 and 3 can have a shape providing minimum distortions into the flow structure, for example, the shape of a cylinder or a cone.

The downhole sensor operates as follows.

The downhole sensor is placed in a borehole so that an axis of the sensors coincides with an axis of the borehole, the sensor 2 is directed towards a dib hole while the sensor 4 is directed towards a borehole mouth. Depending upon a direction of the fluid flow and/or a direction of a downhole sensor movement relative to the flow (round-trip operations in the borehole), it is possible to use the sensor 2 and the sensor 4 in a flow temperature measurement mode or in a flow velocity measurement mode. When lowering the downhole sensor into the borehole or in a static position of the downhole sensor if the fluid flow is directed toward the housing 1, the thermoanemometer sensor 2 is used in the temperature measurement mode while the sensor 4 is used in the flow velocity measurement mode. In this case, the heating element of the sensor 2 is turned off and only its thermosensitive element operates, while the heating and thermosensitive elements of the thermoanemometer sensor 4 operate, and heat generated by the heating element of the sensor 4 has no affects on operation of the thermosensitive element of the sensor 2. Simultaneously, a fluid composition is determined according to a change in an electrical conductance of the fluid between the housings 1 and 3 of the thermoanemometer sensors (cf., “Geofizicheskie issledovania skvazhin: spravochnik mastera po promyslovoi geofizike”/Under the general editorship of V. G. Martynov, N. E. Lazutkina, M. S. Khokhlova.—Moscow: “Infrainzheneria” (Infra-Engineering Publishers), 2009).

If a change in a direction of the flow takes place, i.e., the device is lifted, or if the borehole operates in an injection mode when the flow is directed towards the housing 3, the thermoanemometer sensor 4 is used in the temperature measurement mode while the thermoanemometer sensor 2 is used in the flow velocity measurement mode. In this case, the heating element of the sensor 4 is turned off and only its thermosensitive element operates, while both the heating and thermosensitive elements of the sensor 2 operate, and heat generated by the heating element of the sensor 2 has no affects on operation of the thermosensitive element of the sensor 4.

The sensor is used in a similar way to measure a temperature, a speed and a phase composition of a multi-phase flow (oil, water, gas and mixtures thereof) in pipelines. The downhole sensor is placed in a pipe so that the axis of the sensors coincides with an axis of the pipe, wherein the sensor 2 and the sensor 4 are directed oppositely to each other. Depending upon a direction of the fluid flow, it is possible to use the sensor 2 and the sensor 4 in the flow temperature measurement mode or in the flow velocity measurement mode. In case if the fluid flow is directed towards the housing 1, the thermoanemometer sensor 2 is used in the temperature measurement mode while the sensor 4 is used in the flow velocity measurement mode. In this case, the heating element of the sensor 2 is turned off and only its thermosensitive element operates, while both the heating and thermosensitive elements of the sensor 4 operate, and heat generated by the heating element of the sensor 4 has no affects on operation of the thermosensitive element of the sensor 2. Simultaneously, a fluid composition is determined in accordance with a change in an electrical conductance of the fluid between the housings 1 and 3 of the thermoanemometer sensors.

If a change in a direction of the flow takes place, i.e., when the flow is directed towards the housing 3, the thermoanemometer sensor 4 is used in the temperature measurement mode while the thermoanemometer sensor 2 is used in the flow velocity measurement mode. In this case, the heating element of the sensor 4 is turned off and only its thermosensitive element operates, while both the heating and thermosensitive elements of the sensor 2 operate, and heat generated by the heating element of the sensor 2 has no affects on operation of the thermosensitive element of the sensor 4.

Each sensor is switched from the temperature measurement mode to the velocity measurement mode by a command received from the electronic unit.

The fluid temperature, velocity, and composition are determined from results of the preliminary calibration of respective sensors. Calibration data is stored in memory elements of the electronic unit.

The alternative use of the thermoanemometer sensors in active and passive modes allow determination of a flow direction. For example, the thermoanemometer sensor 4 is first used in the passive temperature measurement mode (the heating member of the sensor 4 is turned off and only its thermosensitive element operates) while the thermoanemometer sensor 2 is used in the active measurement mode (the heating and thermosensitive elements are operated in the sensor 2. A temperature difference ΔT₁ between readings of the sensor 2 and the sensor 4 is recorded. Next, on the contrary, the thermoanemometer sensor 4 is used in the active temperature measurement mode while the thermoanemometer sensor 2 is used in the passive temperature measurement mode. A temperature difference ΔT₂ between readings of the sensor 2 and the sensor 4 is recorded. If the value ΔT₁ in modulus is larger than the value ΔT₂ in modulus, then the flow is directed towards the housing 3. If the value ΔT₁ in modulus is smaller than the value ΔT₂ in modulus, then the flow is directed towards the housing 1.

Use of two thermoanemometers, apart from their direct purpose, for determination of a fluid composition as well widens the functionality of the inventive downhole sensor, while localization of the fluid temperature, velocity, and composition sensors in a single low-volume module enhances the reliability of resulted information directly in a measurement point in real-time mode.

What is claimed is:

1. A downhole sensor comprising:
a first hollow metal housing opened at one end and having
a first thermoanemometer sensor arranged inside the first metal hollow housing, the first thermoanemometer sensor comprising a heating element and a thermosensitive element,
an electrical insulator,
a second hollow metal housing opened at one end, identical to the first metal hollow housing,
a second thermoanemometer sensor arranged inside the second metal hollow housing,
the first and the second metal hollow housings are disposed so that symmetry axes of the housings are aligned, open ends of the housings face each other and are rigidly fastened in the electrical insulator and electrical leads of the first and the second sensors are inside the housings and extend outside through the electrical insulator.

2. The downhole sensor of claim 1, wherein the electrical insulator is coated with a dielectric layer.

3. The downhole sensor of claim 1, wherein the electrical insulator has a shape which provides a minimal flow structure distortion.

4. The downhole sensor of claim 1, wherein the metal housings have a shape which provides a minimal flow structure distortion.

5. The downhole sensor of claim 4, wherein the metal housings have a shape of a cylinder.

6. The downhole sensor of claim 4, wherein the metal housings have a shape of a cone.
